(19) United States
(12) Patent Application Publication
(10) Pub. No.: US 2010/0139474 A1
(43) Pub. Date: Jun. 10, 2010

(54) MUSICAL TONE GENERATING APPARATUS AND MUSICAL TONE GENERATING PROGRAM

(75) Inventors: Yosuke ISHIOKA, Tokyo (JP); Hiroshi Iwase, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/615,462

(22) Filed: Nov. 10, 2009

(30) Foreign Application Priority Data
Dec. 10, 2008 (JP) 2008-314017

(51) Int. Cl. G10H 7/00; G10H 1/00

(52) U.S. Cl. 84/603; 84/602

(57) ABSTRACT

In a musical tone generating apparatus 100, sampling waveform data sampled by a sampling inputting section 15 is, after being divided into an n-number of segments, stored in divided areas W(1) to W(n) of a sampling waveform data area SWDE, respectively. When a chord is played in which a subsequent key is pressed within a predetermined time after the preceding key is pressed (Step SC4 to Step SC5), sampling sounds are produced at the respective pitches of the pressed keys with the use of sampling waveform data in the same divided area W(n) designated by the same pointer n value as that when the preceding key is pressed (Step SC6).

### CROSS-REFERENCE TO RELATED APPLICATION

This application is based upon and claims the benefit of priority from the prior Japanese Patent Application No. 2008-314017, filed Dec. 10, 2008, the entire contents of which is incorporated herein by reference.

### BACKGROUND OF THE INVENTION

1. Field of the Invention

The present invention relates to a musical tone generating apparatus and a musical tone generating program for reproducing a harmonic tone that sounds as though made by a chorus of a plurality of people.

2. Description of the Related Art

Conventionally, a musical tone generating apparatus is known that includes a so-called sampling function (refer to, for example, Japanese Patent Application Laid-Open (Kokai) Publication No. 11-119777). In the sampling function, waveform data sampled by an audio signal inputted via a microphone being converted from an analog signal to a digital signal is stored in a memory, and the waveform data is read out from the memory at a reading speed in accordance with a pitch-specifying operation (such as a key-pressing operation on a keyboard). As a result, a sampling sound is reproduced at an intended pitch.

For example, Japanese Patent No. 2557530 comprises a plurality of memory areas for storing sampling sounds. A technique is disclosed which displays the recorded and unrecorded status of each memory area and areas where sampling sounds are stored which contribute to musical tone generation within the recorded memory areas.

In the above described device disclosed in Japanese Patent Application Laid-Open (Kokai) Publication No. 11-119777, when a series of sampling sounds sampled from human voice sounds such as “a, i, u, e, o” is divided and recorded in a plurality of memory areas, if its mode has been set such that the sampling sounds recorded in the memory areas are reproduced in order one at a time each time a key is pressed, the series of sampling sounds “a, i, u, e, o” is reproduced by consecutively pressing a key. As a result, a keyboard operation that is as enjoyable as playing with a toy can be enjoyed.

However, in a reproduction mode such as this, when a chord is played in which a plurality of keys are pressed, tones constituting the chord respectively corresponding to the pressed keys are not of the same sampling sound. In other words, the keys are not always pressed at the same timing. The timing at which each key is pressed varies especially when the player is an inexperienced beginner.

When the timing at which each key is pressed varies, sampling sounds respectively recorded in the memory areas are reproduced in the order of the keys pressed. As a result, the tones constituting the chord are not of the same sampling sound.

Specifically, for example, in a case where a series of sampling sounds is “a, i, u, e, o” as in the example described above, when keys of a triad chord are pressed and if the timings at which the keys are pressed vary, tones constituting the chord are reproduced as different sampling sounds, “a”, “i”, and “u”. Therefore, there is a problem that the same sampling sounds “a” cannot be generated as tones constituting the chord at pitches respectively corresponding to the pressed keys, and a harmonic tone that sounds as though made by a chorus of a plurality of people cannot be reproduced.

### SUMMARY OF THE INVENTION

The present invention has been achieved to solve the above-described problem. An object of the present invention is to provide a musical tone generating apparatus and a musical tone generating program that can reproduce a harmonic tone that sounds as though made by a chorus of plurality of people.

In order to achieve the above-described object, in accordance with one aspect of the present invention, there is provided a musical tone generating apparatus, comprising: a storage section having a plurality of storage areas respectively storing sound data; a pitch designating operation detecting means for detecting a pitch designating operation performed by a pitch designating means that designates a pitch of a musical tone to be generated; a sound producing means for, every time the pitch designating operation is detected by the pitch designating operation detecting means, producing a sound using sound data stored in a designated storage area of the storage section at the pitch designated by the pitch designating means; a counting means for counting the time between when the pitch designating operation is detected by the pitch designating operation detecting means and when the pitch designating operation is redetected; and a controlling means for, when the time counted by the counting means is within a predetermined time, controlling the sound producing means to designate the same storage area as a storage area of the storage section designated when a previous pitch designating operation is detected, and when the time exceeds the predetermined time, controlling the sound producing means to designate a storage area differing from the storage area of the storage section designated when the previous pitch designating operation is detected.

In accordance with another aspect of the present invention, there is provided a computer-readable storage medium having stored thereon a program that is executable by a computer used as a musical tone generating apparatus including a storage section having a plurality of storage areas respectively storing sound data, the program being executable by the computer to perform a process comprising: a pitch designating operation detecting step of detecting a pitch designating operation performed by a pitch designating means that designates a pitch of a musical tone to be generated; a sound producing step of, every time the pitch designating operation is detected, producing a sound using sound data stored in a designated storage area of the storage section at the pitch designated by the pitch designating means; a counting step of counting the time between when the pitch designating operation is detected and when the pitch designating operation is redetected; and a controlling step of, when the time counted in the counting step is within a predetermined time, designating the same storage area as a storage area of the storage section designated when a previous pitch designating operation is detected, and when the time exceeds the predetermined time, designating a storage area differing from the storage area of the storage section designated when the previous pitch designating operation is detected.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a block diagram showing a configuration of a musical tone generating apparatus according to an embodiment of the present invention;

FIG. 2 is a memory map showing a configuration of a storage area of a RAM 12;

FIG. 3 is a flowchart showing operations of a main routine;

FIG. 4 is a flowchart showing operations of sampling processing;

FIG. 5 is a flowchart showing operations of key-press processing;

FIG. 6 is a flowchart showing operations of timer interrupt processing; and

FIG. 7 is a flowchart showing operations of key-release processing.

### DETAILED DESCRIPTION OF THE PREFERRED EMBODIMENT

The present invention will hereinafter be described in detail with reference to the preferred embodiment shown in the accompanying drawings.

A. Configuration

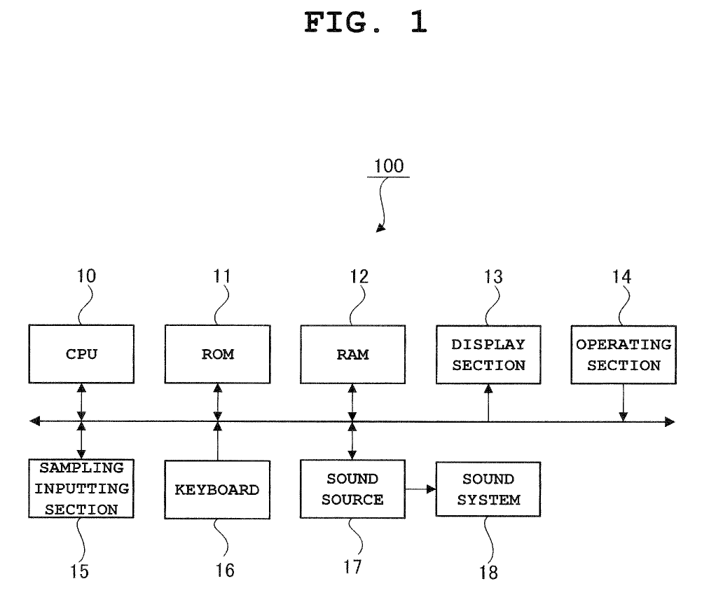

FIG. 1 is a block diagram showing an overall configuration of a musical tone generating apparatus 100 according to an embodiment of the present invention.

In FIG. 1, a central processing unit (CPU) 10 controls each section of the musical tone generating apparatus 100 based on events provided by an operating section 14 and a keyboard 16. Operations of processing related to the scope of the present invention will be described in detail hereafter.

A read-only memory (ROM) 11 stores therein various program data including programs for a main routine, sampling processing, key-press processing, and key-release processing performed by the CPU 10, described hereafter.

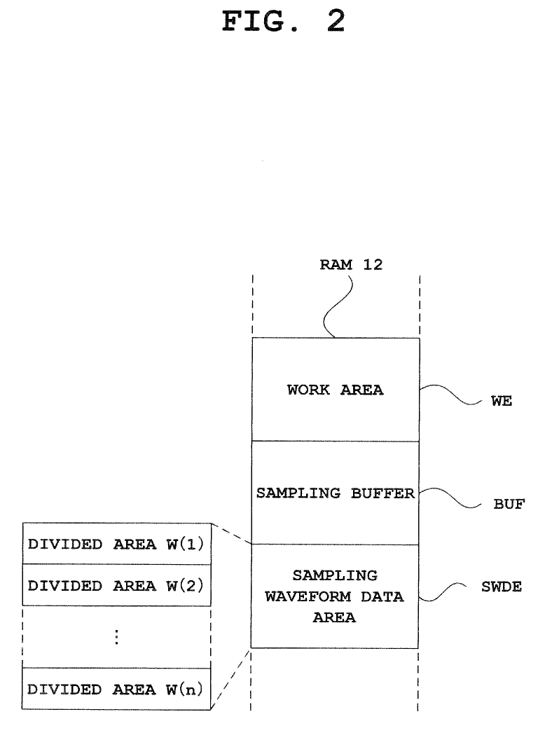

A random access memory (RAM) 12 includes a work area WE, a sampling buffer BUF, and a sampling waveform data area SWDE as shown in FIG. 2. The work area WE temporarily stores therein various register/flag data used in processing performed by the CPU 10.

The sampling buffer BUF temporarily stores therein sampling waveform data loaded from a sampling inputting section 15 described hereafter under control of the CPU 10. The sampling waveform data area SWDE has divided areas W(1) to W(n), and sampling waveform data in the sampling buffer BUF is, after being divided into an n-number of segments, transferred to and stored in the divided areas W(1) to W(n), respectively.

A display section 13 includes, for example, a liquid crystal display (LCD) panel (not shown) and a display driver (not shown) that drives the LCD panel to perform display in accordance with a display control signal provided by the CPU 10. An apparatus setting status that is set corresponding to the operation of the operating section 14, an operation status, or the like is displayed on the screen of this display section 13.

The operating section 14 includes switches and operating keys arranged on a console panel (not shown), and generates an event corresponding to an operation. This event is loaded by key-scanning by the CPU 10. The switches arranged in the operating section 14 are, for example, a power switch (not shown), a sampling switch for instructing the initiation of sampling, etc.

The sampling inputting section 15 amplifies an audio signal inputted via a microphone or an audio signal provided via an audio inputting terminal to a fixed level in accordance with a sampling-start instruction from the CPU 10, and then outputs sampling waveform data obtained by converting the amplified audio signal from an analog signal to a digital signal at a predetermined sampling frequency.

Sampling waveform data outputted from the sampling inputting section 15 is, after being temporarily stored in the sampling buffer BUF of the RAM 12 described above under control of the CPU 10, divided into an n-number of segments in the sampling buffer BUF and transferred to the divided areas W(1) to W(n) of the sampling waveform data area SWDE.

The keyboard 16 generates a key-ON/key-OFF event and performance information such as a key number and velocity in accordance with key-pressing operations.

The sound source 17, which is configured by a known waveform memory reading system, includes a plurality of sound producing channels capable of simultaneous sound production, and generates a musical tone output (sampling sound) in accordance with a musical tone command generated by the CPU 10 based on performance information outputted from the keyboard 16.

The sound system 18 converts a musical tone output from the sound source 17 from a digital signal to an analog signal and produces a sound from a speaker by amplifying the converted analog signal.

B. Operations

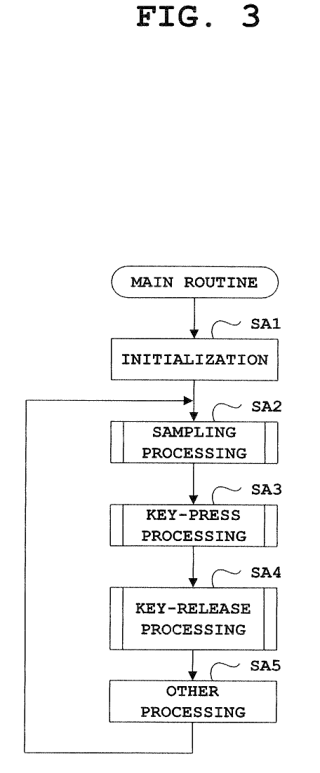

Next, operations performed by the musical tone generating apparatus 100 configured as described above will be described with reference to FIGS. 3 to 7.

FIG. 3 is a flowchart showing operations of the main routine performed by the CPU 10.

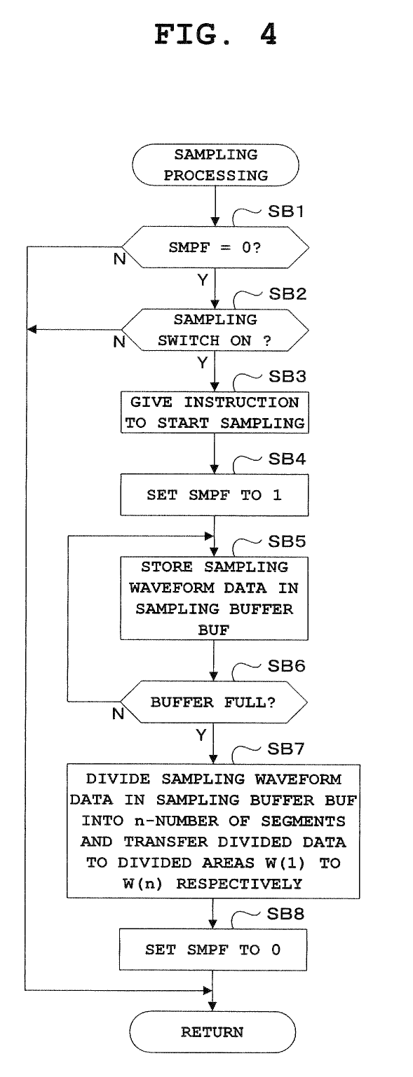

FIG. 4 is a flowchart showing operations of sampling processing called from the main routine.

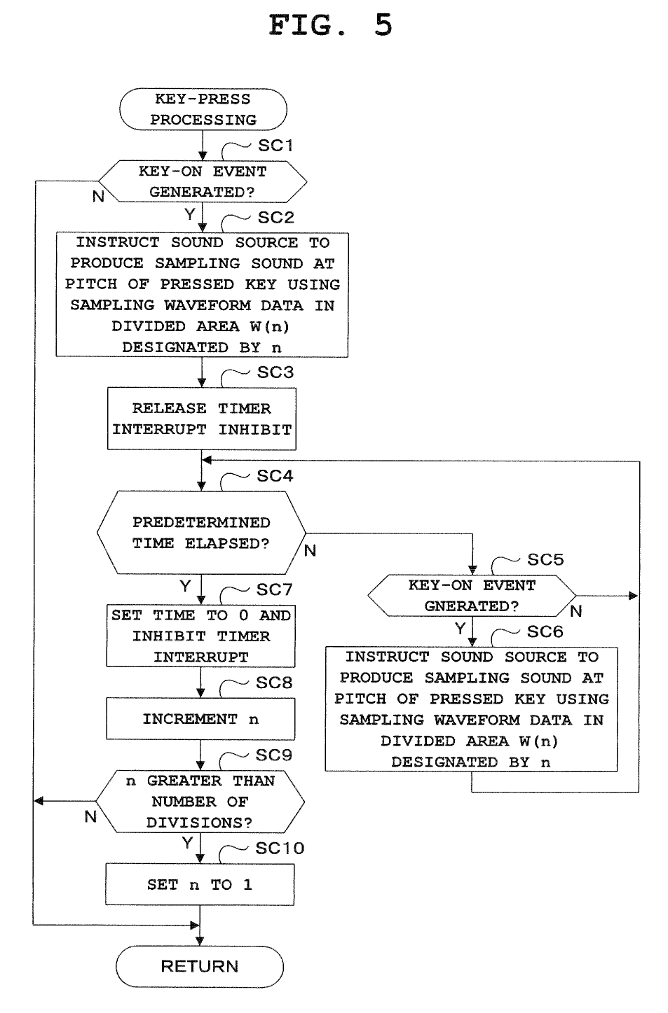

FIG. 5 is a flowchart showing operations of key-press processing called from the main routine.

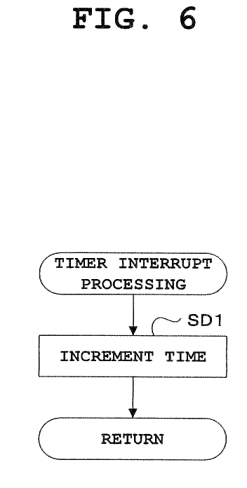

FIG. 6 is a flowchart showing operations of timer interrupt processing.

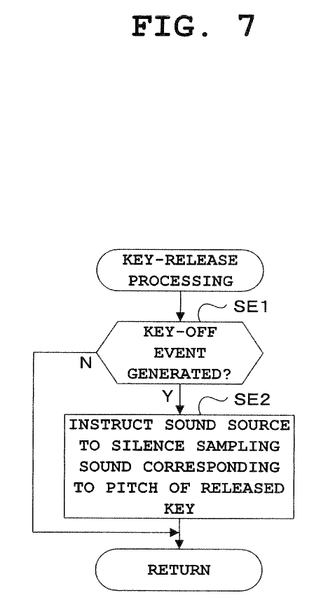

FIG. 7 is a flowchart showing operations of key-release processing called from the main routine.

(1) Operations of the Main Routine

When the musical tone generating apparatus 100 is turned ON, the CPU 10 runs the main routine shown in FIG. 3 and proceeds to the processing at Step SA1 to perform initialization, such as resetting various registers and flags stored in the work area WE of the RAM 12, and setting initial values.

Specifically, the CPU 10 sets a pointer n that designates a divided area W(1) to W(n) provided in the sampling waveform data area SWDE of the RAM 12 to an initial value 1. The purpose of the pointer n will be described hereafter.

At Step SA1, the CPU 10 also instructs the sound source 17 to reset various registers and flags.

When initialization is completed, the CPU 10 proceeds to Step SA2 and performs the sampling processing. In the sampling processing, as described hereafter, if sampling is not in progress, the CPU 10 instructs the sampling inputting section 15 to start sampling in accordance with a sampling switch ON operation. As a result, sampling waveform data is outputted from the sampling inputting section 15, and stored in the sampling buffer BUF of the RAM 12 until the sampling buffer BUF is full.

Then, when the sampling buffer BUF is full, the sampling waveform data in the sampling buffer BUF is divided into an n-number of segments, and transferred to the divided areas W(1) to W(n) in the sampling waveform data area SWDE, respectively.

Next, at Step SA3, the CPU 10 performs the key-press processing.

As described hereafter, in the key-press processing, when a subsequent key is pressed within a predetermined time after the preceding key is pressed or, in other words, when a plurality of keys are pressed for a chord performance, sampling sounds are produced at the respective pitches of the pressed keys with the use of sampling waveform data in the same divided area W(n) designated by the same pointer n value.

On the other hand, when a single-tone key-pressing operation is performed in which a subsequent key is pressed after a predetermined time from when the preceding key is pressed, a sampling sound is produced at the pitch of the pressed key with the use of sampling waveform data in the divided area W(n) designated by the pointer n that is incremented each time a key is pressed.

Then, at Step SA4, the CPU 10 judges whether or not a key-OFF event has been generated by a key being released. When judged that the key-OFF event has been generated, the CPU 10 performs the key-release processing for instructing the sampled sound corresponding to the pitch of the released key to be silenced.

Next, at Step SA5, the CPU 10 performs other processing such as displaying the apparatus setting status and the operation status on a screen. Hereafter, the CPU 10 repeatedly performs Step SA2 to Step SA5 described above until the musical tone generating apparatus 100 is turned OFF.

(2) Operations of the Sampling Processing

Next, operations of switch processing will be described with reference to FIG. 4. When the switching process is performed at Step SA2 (see

FIG. 3) in the main routine described above, the CPU 10 proceeds to Step SB1 shown in FIG. 4 and judges whether or not a flag SMPF is “0”.

As described hereafter, the SMPF flag indicates that sampling is in progress when it is “1” and indicates that sampling has been stopped when it is “0”. Therefore, the CPU 10 judges whether or not sampling has been stopped at Step SB1.

Here, when the SMPF flag is “1” (sampling in progress), the judgment result is “NO” and the sampling processing is terminated. In other words, when sampling is in progress, operation of the sampling switch instructing the initiation of sampling is disabled.

On the other hand, when the SMPF flag is “0” (sampling has been stopped), the judgment result at Step SB1 is “YES”. Accordingly, the CPU 10 proceeds to Step SB2 and judges whether or not a sampling switch ON operation has been performed.

When the sampling switch has not been turned ON, the judgment result is “NO” and the sampling processing is terminated. When the sampling switch has been turned ON, the judgment result is “YES” and the CPU 10 proceeds to Step SB3.

At Step SB3, the CPU 10 instructs the sampling inputting section 15 to start sampling. Accordingly, the sampling inputting section 15 amplifies an audio signal inputted via a microphone or an audio signal provided from an audio inputting terminal to a fixed level, and outputs sampling waveform data acquired by converting the amplified audio signal from an analog signal to a digital signal at a predetermined sampling frequency. Next, at Step SB4, the CPU 10 sets the SMPF flag to “1” to indicate that sampling is in progress.

Next, at Step SB5 and Step SB6, the CPU 10 sequentially stores the sampling waveform data outputted from the sampling inputting section 15 into the sampling buffer BUF of the RAM 12 until the sampling buffer BUF is full.

When the sampling buffer BUF is full, the judgment result at Step SB6 is “YES”. Accordingly, the CPU 10 proceeds to Step SB7 to divide the sampling waveform data in the sampling buffer BUF into an n-number of segments, and then transfers them to the divided areas W(1) to W(n) in the sampling waveform data area SWDE, respectively.

Then, the CPU 10 proceeds to Step SB8, and after resetting the SMPF flag to “0”, terminates the sampling processing. Note that the number of segments into which sampling waveform data is divided and then transferred may be a predetermined value set in advance or may be specified by user operation.

(3) Operations of the Key-Press Processing

Next, operations of the key-press processing will be described with reference to FIG. 5.

When the key-press processing is performed at Step SA3 (see FIG. 3) in the main routine described above, the CPU 10 proceeds to Step SC1 in FIG. 5 and judges whether or not a key-ON event has been generated by a key being pressed.

When the key-ON event has not been generated, the judgment result is “NO” and the key-press processing is terminated. When the key-ON event has been generated by a key being pressed, the judgment result at Step SC1 is “YES” and the CPU 10 proceeds to Step SC2.

At Step SC2, the CPU 10 instructs the sound source 17 to produce a sampling sound at the pitch of the pressed key using sampling waveform data in the divided area W(n) designated by the pointer n.

Since the pointer n has been set to the initial value “1” during initialization at Step SA1 described above (see FIG. 3), when a first key-pressing operation is performed, sampling waveform data in the divided area W(1) is designated.

Next, at Step SC3, the CPU 10 releases the timer interrupt inhibit, and performs timer interrupt processing shown in FIG. 6 for each timer clock. Then, at Step SD1, the CPU 10 increments a timer counter TIME to perform clocking.

When the timer counter TIME starts clocking, the CPU 10 proceeds to Step SC4 in FIG. 5, and judges whether or not a predetermined time has elapsed after the preceding key has been pressed based on the value of the timer counter TIME.

When a predetermined time has not elapsed after the preceding key has been pressed, the judgment result at Step SC4 is “NO” and the CPU 10 proceeds to Step SC5.

At Step SC5, the CPU 10 judges whether or not the key-ON event has been generated by a key being pressed. In other words, at Step SC5, the CPU 10 judges whether or not a subsequent key has been pressed within a predetermined time after the preceding key has been pressed.

When a key has been pressed within a predetermined time after the preceding key has been pressed, the judgment result at Step SC5 is “YES” and the CPU 10 proceeds to Step SC6. At Step SC6, the CPU 10 instructs the sound source 17 to produce a sampling sound at the pitch of the pressed key using the sampling waveform data in the divided area W(n) designated by the pointer n, and then returns to Step SC4 described above.

Hereafter, Step SC6 is performed every time a new key is pressed within a predetermined time after the preceding key is pressed.

For example, in a case where a first key is pressed and, after a sampling sound is produced at the pitch of the pressed key with the use of sampling waveform data in the divided area W(1), new keys are sequentially pressed within a predetermined time after the first key is pressed, sampling sounds are produced at the respective pitches of the pressed keys with the use of sampling waveform data in the same divided area W(1).

When the predetermined time elapses after the preceding key is pressed, the judgment result at Step SC4 is “YES”, and the CPU 10 proceeds to Step SC7. At Step SC7, the CPU 10 resets the timer counter TIME to 0, and sets timer interrupt inhibit.

As a result, the timer interrupt processing shown in FIG. 6 is completed. Next, at Step SC8, the CPU 10 increments the pointer n designating the divided area.

At subsequent Step SC9, the CPU 10 judges whether or not the incremented pointer n exceeds the number of divisions (the number of divided areas W(1) to W(n)).

When the incremented pointer n does not exceed the number of divisions, the judgment result is “NO” and the key-press processing is terminated. On the other hand, when the incremented pointer n exceeds the number of divisions, the judgment result is “YES”, and the CPU 10 proceeds to the subsequent Step SC10. At Step SC10, the CPU 10 resets the pointer n to the initial value “1”, and terminates the key-press processing.

As just described, in the key-press processing, when a subsequent key is pressed within a predetermined time after the preceding key is pressed or, in other words, when a plurality of keys are pressed for a chord performance, sampling sounds are produced at the respective pitches of the pressed keys with the use of sampling waveform data in the same divided area W(n) designated by the same pointer n value.

On the other hand, when the single-tone key-pressing operation is performed in which a subsequent key is pressed after a predetermined time from when the preceding key is pressed, a sampling sound is produced at the pitch of the pressed key with the use of sampling waveform data in the divided area W(n) designated by the pointer n that is incremented each time a key is pressed.

(4) Operations of the Key-Release Processing

Operations of the key-release processing will be described with reference to FIG. 7.

When the key-release processing is performed at Step SA4 in the main routine described above (see FIG. 3), the CPU 10 proceeds to Step SE1 in FIG. 7 and judges whether or not a key-OFF event has been generated by a key being released.

When the key-OFF event has not been generated, the judgment result is “NO” and the key-release processing is terminated.

On the other hand, when the key-OFF event has been generated by a key being released, the judgment result is “YES”, and the CPU 10 proceeds to Step SE2. At Step SE2, the CPU 10 instructs the sound source 17 to silence the sampling sound corresponding to the pitch of the released key, and terminates he key-release processing.

As described above, according to the embodiment, sampling waveform data sampled by the sampling inputting section 15 is, after being divided into an n-number of segments, stored in the divided areas W(1) to W(n) of the sampling waveform data area SWDE, respectively.

Then, when a chord is played in which a subsequent key is pressed within a predetermined time after the preceding key is pressed, sampling sounds are produced at the respective pitches of the pressed keys with the use of sampling waveform data in the same divided area W(n) designated by the same pointer n value.

On the other hand, when the single-tone key-pressing operation is performed in which a subsequent key is pressed after a predetermined time from when the preceding key is pressed, a sampling sound is produced at the pitch of the pressed key with the use of sampling waveform data in the divided area W(n) designated by the pointer n that is incremented each time a key is pressed.

Therefore, for example, in a case where sampling waveform data of human voice sounds “a, i, u, e, o” are stored in the divided areas W(1) to W(5), when a chord is played in which a subsequent key is pressed within a predetermined time after the preceding key is pressed, the same sampling sounds “a” are produced as tones constituting the chord at respective pitches corresponding to the pressed keys in a first chord key-pressing operation.

In the following chord key-pressing operation, the same sampling sounds “i” are produced as tones constituting the chord at respective pitches corresponding to the pressed keys. Subsequently, the chords of the sampling sounds “u” to “o” are similarly produced. Therefore, harmonic tones that sound as though made by a chorus of a plurality of people can be reproduced.

While the present invention has been described with reference to the preferred embodiments, it is intended that the invention be not limited by any of the details of the description therein but includes all the embodiments which fall within the scope of the appended claims.

What is claimed is:

1. A musical tone generating apparatus, comprising:
a storage section having a plurality of storage areas respectively storing sound data;
a pitch designating operation detecting means for detecting a pitch designating operation performed by a pitch designating means that designates a pitch of a musical tone to be generated;
a sound producing means for, every time the pitch designating operation is detected by the pitch designating operation detecting means, producing a sound using sound data stored in a designated storage area of the storage section at the pitch designated by the pitch designating means;
a counting means for counting the time between when the pitch designating operation is detected by the pitch designating operation detecting means and when the pitch designating operation is redetected; and
a controlling means for, when the time counted by the counting means is within a predetermined time, controlling the sound producing means to designate the same storage area as a storage area of the storage section designated when a previous pitch designating operation is detected, and when the time exceeds the predetermined time, controlling the sound producing means to designate a storage area differing from the storage area of the storage section designated when the previous pitch designating operation is detected.

2. The musical tone generating apparatus according to claim 1, further comprising:
a sampling means for dividing and storing sampling sound data acquired by sampling audio inputted from an external source as sound data in each storage area of the storage section.

3. The musical tone generating apparatus according to claim 1, wherein the pitch designating means includes a keyboard having a plurality of keys, and the pitch designating operation detecting means detects an operation of pressing a key as the pitch designating operation.

4. The musical tone generating apparatus according to claim 1, further comprising:
a pitch designation termination detecting means for detecting termination of the pitch designating operation by the pitch designating means; and
a silencing means for silencing the sound produced at the pitch of which designation has been terminated in response to detection of the designation termination by the pitch designation termination detecting means.

5. The musical tone generating apparatus according to claim 4, wherein the pitch designating means includes a keyboard having a plurality of keys, and the pitch designation termination detecting means detects an operation of releasing a key as the pitch designation termination.

6. A computer-readable storage medium having stored thereon a program that is executable by a computer used as a musical tone generating apparatus including a storage section having a plurality of storage areas respectively storing sound data, the program being executable by the computer to perform a process comprising:
a pitch designating operation detecting step of detecting a pitch designating operation performed by a pitch designating means that designates a pitch of a musical tone to be generated;
a sound producing step of, every time the pitch designating operation is detected, producing a sound using sound data stored in a designated storage area of the storage section at the pitch designated by the pitch designating means;
a counting step of counting the time between when the pitch designating operation is detected and when the pitch designating operation is redetected; and
a controlling step of, when the time counted in the counting step is within a predetermined time, designating the same storage area as a storage area of the storage section designated when a previous pitch designating operation is detected, and when the time exceeds the predetermined time, designating a storage area differing from the storage area of the storage section designated when the previous pitch designating operation is detected.
